(19) United States
(12) Patent Application Publication
(10) Pub. No.: US 2009/0005936 A1
(43) Pub. Date: Jan. 1, 2009

(54) Systems for Detecting Animate Objects in a Vehicle Compartment

(75) Inventors: Alan L. Browne, Grosse Pointe, MI (US); Nancy L. Johnson, Northville, MI (US); William B. Carter, Santa Monica, CA (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/206,893

(22) Filed: Sep. 9, 2008

Related U.S. Application Data
(63) Continuation-in-part of application No. 11/933,682, filed on Nov. 1, 2007.
(60) Provisional application No. 60/863,882, filed on Nov. 1, 2006.

(51) Int. Cl. B60R 21/01; G08B 23/00

(52) U.S. Cl. 701/45; 340/573.1; 297/217.2

(57) ABSTRACT

A sensor assembly includes a sensor configured to detect a predetermined condition, a transmitter operatively connected to the sensor and configured to selectively transmit a wireless signal when the sensor detects the predetermined condition, and at least one energy harvester configured to capture energy from the environment. The sensor assembly is configured to transmit energy captured by the energy harvester to the transmitter.

### CROSS REFERENCE TO RELATED APPLICATION

This application is a continuation-in-part of U.S. patent application Ser. No. 11/933,682, filed Nov. 1, 2007, which claims the benefit of U.S. Provisional Application No. 60/863,882, filed Nov. 1, 2006, both of which are hereby incorporated by reference in their entireties.

### TECHNICAL FIELD

This invention relates to active material based sensors configured to detect animate objects inside a vehicle compartment.

### BACKGROUND OF THE INVENTION

Vehicle bodies typically define an enclosed passenger compartment. The passenger compartment has seats for transporting passengers therein, and is typically enclosed to protect passengers from the elements. The passenger compartment is accessible through doors, windows or other apertures that are lockable to prevent unauthorized entry into the passenger compartment such as when the vehicle is unattended while parked. A passenger seat may be releasably connected to the vehicle body such that the passenger seat is selectively removable from the body to enlarge the cargo capacity of the body and/or attached within the body at multiple locations to conveniently reconfigure the interior of the vehicle.

Vehicle bodies also typically include an enclosed storage area. The storage area may be open to, or part of, the passenger compartment, as found in minivans and sport utility vehicles. The storage area may also be a separate compartment that is inaccessible from the passenger compartment, such as a trunk in a sedan or coupe. The storage area in vehicles such as minivans and sport utility vehicles is typically accessible from the outside of the vehicle through a rear closure such as a liftgate. Trunks are typically accessible through a closure such as a decklid. The storage compartment closures are lockable to prevent unauthorized access to items in the storage compartment.

Some vehicles also include occupant sensors configured to determine whether a seat is occupied. The occupant sensors may be used for seat belt alert systems, air bag systems, etc.

### SUMMARY OF THE INVENTION

A sensor assembly includes a sensor configured to detect a predetermined condition, a transmitter operatively connected to the sensor and configured to selectively transmit a wireless signal when the sensor detects the predetermined condition, and at least one energy harvester configured to capture energy from the environment. The sensor assembly is configured to transmit energy captured by the energy harvester to the transmitter.

A system for detecting an animate object inside a vehicle compartment includes a vehicle body defining the vehicle compartment, a controller, and a sensor assembly. The sensor assembly includes a sensor, a transmitter, and an energy harvester. The sensor is configured to detect a moving animate object inside the vehicle compartment and to transmit a first signal to the transmitter indicative of whether a moving animate object is detected by the sensor. The transmitter is operatively connected to the sensor and configured to transmit a wireless second signal in response to the receiving the first signal.

The energy harvester is configured to capture energy from the sensor assembly environment, and the sensor assembly is configured to transmit energy captured by the energy harvester to the transmitter. A receiver is operatively connected to the controller and configured to receive the second signal from the transmitter. The controller is configured to generate a command signal when the controller determines that at least one predetermined condition exists. The at least one predetermined condition includes the receiver receiving the second signal from the transmitter.

Another system for detecting an animate object inside a vehicle compartment includes a vehicle body defining the vehicle compartment and a sensor. The sensor includes an active material that is configured to change a material attribute in response to being deformed or displaced, is mounted with respect to the vehicle body to receive force from a moving animate object inside the vehicle compartment, and is configured to generate a signal that is indicative of the active material being deformed or displaced.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, partial cutaway view of a vehicle including a plurality of sensors;

FIG. 2A is a schematic depiction of one of the sensors of FIG. 1 in an undeformed state;

FIG. 2B is a schematic depiction of the sensor of FIG. 2A in a deformed state;

FIG. 3 is a motion detection system including the sensors of FIG. 1;

FIG. 4 is a schematic depiction of an alternative sensor assembly configuration for use with the motion detection system of FIG. 3;

FIG. 5 is a schematic depiction of another alternative sensor assembly configuration for use with the motion detection system of FIG. 3;

FIG. 6 is a schematic depiction of yet another alternative sensor assembly configuration for use with the motion detection system of FIG. 3; and

FIG. 7 is a schematic depiction of yet another alternative sensor assembly configuration for use with the motion detection system of FIG. 3.

### DESCRIPTION OF THE PREFERRED EMBODIMENTS

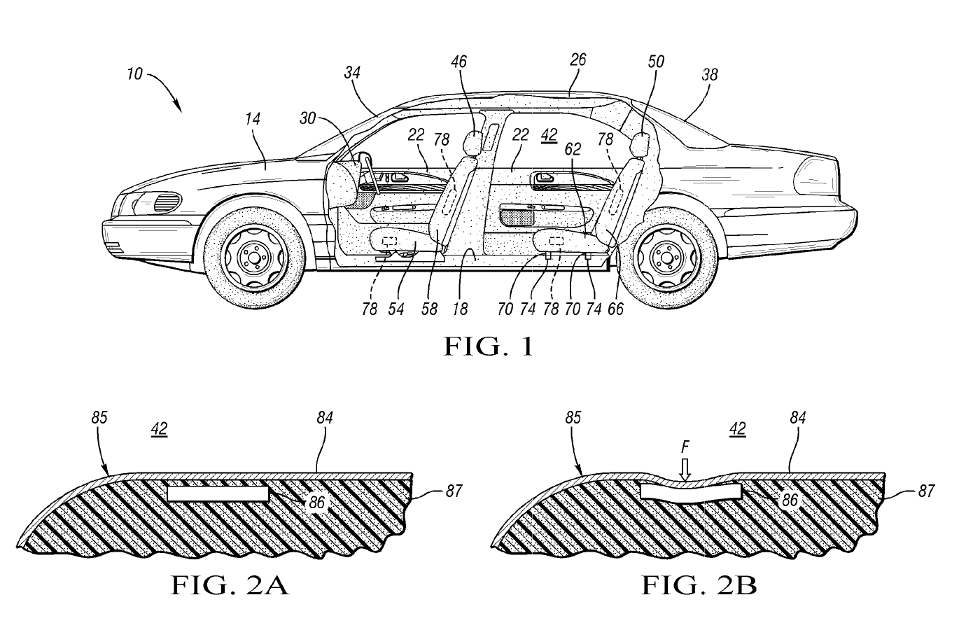

Referring to FIG. 1, a vehicle 10 including a vehicle body 14 is schematically depicted. The vehicle body 14 in the embodiment depicted is a sedan; however, it should be noted that any vehicle body configuration may be employed within the scope of the claimed invention, such as station wagons, coupes, minivans, sport utility vehicles, airplanes, boats, busses, etc.

The vehicle body 14 includes a floor 18, doors 22, a roof 26, an instrument panel 30, a windshield 34, and a rear window 38, all of which cooperate to define a passenger compartment 42. The vehicle body 14 also defines a storage compartment which, in the embodiment depicted, is a trunk space located rearward of the passenger compartment 42, as understood by those skilled in the art. The vehicle 10 includes front seats 46 and rear seats 50 in the passenger compartment 42. The front seats 46 include a lower seat portion 54 and a seatback portion 58. Similarly, the rear seats 50 include a lower seat portion 62 and a seatback portion 66.

The front seats 46 in the embodiment depicted are mounted with respect to the floor 18 via tracks or rails, as understood by those skilled in the art, to enable the seats 46 to be selectively moved fore and aft within the passenger compartment 42. The rear seats 50 include fastening elements 70 that are mounted to the lower seat portion 62 and that are releasably engageable with corresponding fastening elements 74, which are mounted to the floor 18. Accordingly, the rear sets 50 are mountable to the floor 18 by engaging each of fastening elements 70 with a corresponding fastening element 74. The rear seats 50 are removable from the passenger compartment 42 by disengaging the fastening elements 70 from fastening elements 74, for example, to increase the cargo capacity of the vehicle body 14. Exemplary fastening elements 70, 74 that are releasably engageable with one another include latches and strikers.

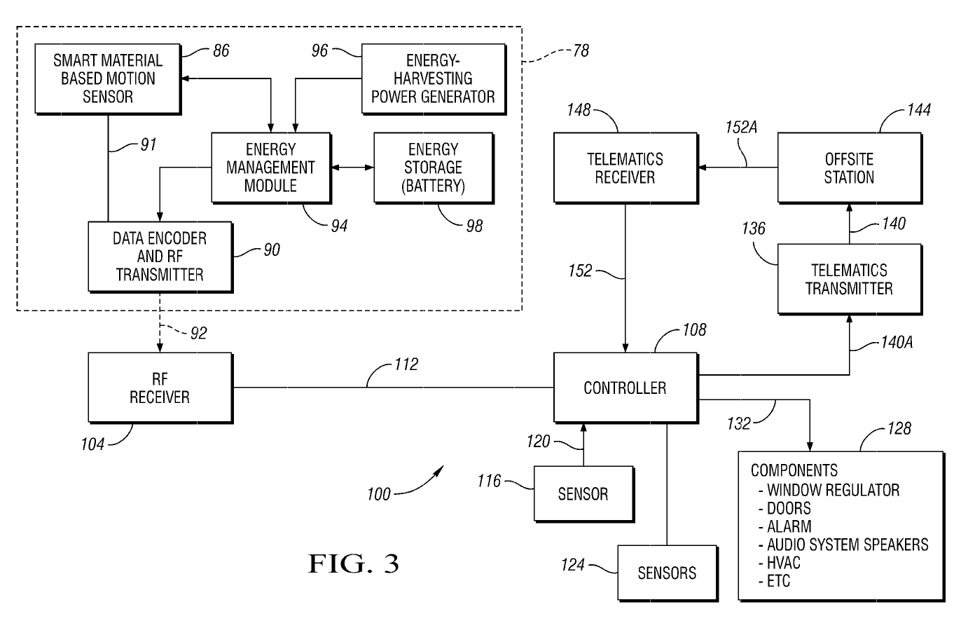

The vehicle 10 includes sensor assemblies 78, each having at least one sensor (shown at 86 in FIGS. 2A, 2B, and 3). In the embodiment depicted, sensor assemblies 78 are positioned in the lower seat portions 54, 62 and the seatback portions 58, 66 of the passenger seats 46, 50. The sensor 86 of each sensor assembly is positioned in a location in which movement of an animate object inside the passenger compartment 42 is likely to result in a force being transmitted to at least one of the sensors 86. Referring to FIG. 2A, each sensor 86 may be positioned with respect to a member 84 that defines a surface 85. Surface 85 partially defines, or is exposed within, the passenger compartment 42. The member 84 and the sensor 86 are shown in FIG. 2A in an undeformed state. Referring to FIG. 2B, an animate object within the passenger compartment 42 may contact surface 85, and thereby impart a force F to the member 84. If the member 84 is flexible, then the member 84 deforms in response to the force F, and thereby transfers force F to the sensor 86, which in turn is deformed or displaced, as shown in FIG. 2B, in response to the force F. Alternatively, if member 84 is rigid, then the member 84 may be selectively movable to transmit force to the sensor 86 to deform or displace the sensor.

For example, the member 84 may be a seat cover for one of the lower seat portions 54, 62 or one of the seatback portions 58, 66, and may be a flexible material such as cloth, leather, vinyl, etc., as understood by those skilled in the art. A force F is exerted on a seat cover when an occupant sits on one of the seat assemblies 46, 50. Accordingly, the sensors 86 of sensor assemblies 78 are configured to detect the presence of an occupant in one of the seat assemblies 46, 50. In an exemplary embodiment, the sensors 86 in seat assemblies are within a seat cushion 87 so that the sensors 86 are isolated from motion and vibration transmitted via rigid members of the vehicle body 14. By isolating the sensors 86 in the seat cushions (or with seat springs), background noise is minimized.

Other exemplary positions for sensors 86 include the floor 18, the storage compartment, the doors 22, on the instrument panel 30, at the connection of the seats 46, 50 to the passenger compartment floor 18, etc. If a sensor 86 is mounted with respect to the floor 18, member 84 is representative of carpet or other flexible floor covering. If a sensor 86 is mounted with respect to the doors 22, then member 84 is representative of an interior trim panel of the doors 22. If a sensor 86 is mounted with respect to the instrument panel 30, then member 84 is representative of an exterior surface thereof.

The sensors 86 are configured such that they create an electrical charge or current when deformed or displaced by a force applied thereto. In an exemplary embodiment, the sensors 86 comprise an active material that generates an electrical charge or current when deformed, such as piezoelectric material. As understood by those skilled in the art, piezoelectric materials produce an electrical charge when deformed as a result of mechanical stress. In the event that piezoelectric material is employed, it is preferably in the form of piezopolymers, for example as thin and flexible uni-morph, bi-morph, patches, woven fibers, etc. Other materials that may be employed to generate a charge or current in response to deformation or displacement include piezoceramics as fibers, unimorphs, bimorphs, patches, etc.; electroactive polymers (EAP), for example, as thin and flexible patches; membranes/enclosed cavities containing fluids with magnetic particles (such as magnetorheological (MR) fluids) surrounded by electrical conducting medium—such as highly conductive rubber—the motion/flow of which fluid would result in a current/voltage being generated; magnetostrictive composites wherein flexure of the magnetostrictive material generates a changing magnetic field and induces a current in a coil; magnetostrictive fibers wherein vibration of the fibers generates a changing magnetic field, ionic polymer metal composites; magnetic shape memory alloys (MSMA); multiferroic materials (hybrid piezo/magnetostrictive); ferroelectret foams; resonant magnet/coil combinations; etc.

Referring to FIG. 3, wherein like reference numbers refer to like components from FIG. 1, a sensor assembly 78 is schematically depicted. The sensor assembly 78 depicted in FIG. 3 is representative of all sensor assemblies depicted at 78 in FIG. 1. The sensor assembly 78 includes sensor 86, which is configured to detect a predetermined condition. In the embodiment depicted, the predetermined condition monitored by the sensor 86 is movement of an animate object inside the passenger compartment, as previously noted. The sensor assembly 78 further includes a transmitter 90 that is in electrical communication with the sensor 86 via conductive wires 91 to receive at least part of the electrical current generated by the sensor 86 when the sensor 86 is deformed or displaced. The electrical current transmitted via wires 91 is a signal indicative of the sensor 86 being deformed or displaced. Alternatively, and within the scope of the claimed invention, the transmitter 90 may be in wireless communication with the sensor 86. The transmitter 90 includes a data encoder and is configured to selectively transmit a wireless signal 92 in response to the electrical current from the sensor 86, i.e., when the sensor 86 is deformed or displaced and thereby detects the presence of a moving object within the passenger compartment. Wireless signal 92 in one embodiment is an electromagnetic wave, e.g., in the radiofrequency spectrum. Wireless signal 92 may have other forms within the scope of the claimed invention. For example, the transmitter 90 may be configured to generate audio signals and vibrational signals.

The sensor assembly 78 further includes an energy management module 94, an energy harvester 96, and an energy storage device 98, such as a battery or capacitor. The energy harvester 96 is configured to capture energy from the environment of the sensor assembly 78 and convert the captured energy to electrical energy. Environmental sources of energy for the harvester 96 include, for example, motion of interior or engine components caused by vehicle operation (motion of animate objects, vehicle-induced motion of seats, shock-absorber action, vibrations, braking, etc.), flexing of vehicle components, light (infra-red or optical), thermal energy, electromagnetic energy (electromagnetic noise, radiofrequency waves) electrical charge buildup on the vehicle frame, etc. Environmental energy may also be harvested from any motion or electrical noise within the vehicle compartment. Within the scope of the claimed invention, an energy harvester includes, but is not limited to, all devices or materials that convert mechanical motion (including vibration), ambient electromagnetic fields, ambient acoustics, or temperature changes to electricity.

Those skilled in the art will recognize a variety of materials and devices that may be employed to capture energy from environmental sources. For example, energy harvester 96 may include piezoelectric materials, which generate an electrical charge or current when subjected to mechanical stress. In an exemplary embodiment, the piezoelectric material is either a piezoceramic or piezopolymer as a thin and flexible uni-morph, bi-morph, etc. patch. The energy harverster 96 may include a solar cell (silicon, polymeric) to convert light to electrical energy. The energy harvester 96 may include pyroelectric elements (such as piezoelectric polymer materials that generate electric charge in response to temperature changes). The energy harvester 96 may include thermoelectrics, Peltier elements, thermocouples, etc. that generate electric current in response to temperature changes. The energy harvester 96 may also include magnet and coil devices that are configured such that vehicle motion, flexing of vehicle components, etc. cause a magnet to move relative to a coil, thereby inducing current in the coil. The energy harvester 96 may also be a magnetic fluid that changes current in a coil in response to motion.

Sensor 86 in the embodiment depicted also functions as an energy harvester. That is, the sensor 86 converts energy available from the sensor assembly environment to electrical energy. The current generated by the sensor 86 and transmitted via conductive wires 91 is used by the transmitter 90 to generate the wireless signal 92. The energy management module 94 provides electrical communication between the sensor 86 and the energy storage device 98 such that part of the electrical energy generated by the sensor 86 is stored in the storage device 98. The energy management module 94 also provides electrical communication between the energy harvester 96 and the energy storage device 98 such that the energy captured and converted by the energy harvester 96 is stored in the energy storage device 98. Accordingly, the energy storage device 98 stores captured energy from the sensor 86 and the energy harvester 98.

The energy management module 94 provides electrical communication between the transmitter 90 and the energy storage device 98 so that the transmitter 90 receives the captured energy from the energy storage device 98 and uses the captured energy to amplify the wireless signal 92. Thus, the sensor assembly 78 is self-powered, i.e., the sensor assembly 78 does not require an external source of electrical energy to power the sensor 86 and the transmitter 90. The energy management module 94 may also be configured to provide electrical communication between the transmitter 90 and the energy harvester 96 so that, if the energy harvester 96 is generating electrical energy when the transmitter 90 is producing wireless signal 92, the energy from the harvester 96 is sent to the transmitter 90 instead of the energy storage device 98.

It should be noted that in an alternative embodiment, and within the scope of the claimed invention, sensor 86 may be powered by the energy harvester 96 and the energy storage device 98, and thus receive energy via the energy management module. For example, if sensor 86 is powered by the energy storage device 98 or by an electrical connection to the vehicle's electrical system, then exemplary configurations for sensor 86 may include conductive polymers, variable geometry capacitors (such as electroactive polymers), metal rubber (i.e., conductive rubber or elastomer), stretchable resistors that change resistance with displacement, contact switches, air capacitors, compressible inductor coils, variable transformers (LVDTs), and magnet/coil systems. Transduction geometries of the sensor may include bowtie, cantilever, etc. keyed to particular active material geometries that channel wideband motion into narrowband motion (for efficiency of piezos, etc. Protocols that may be implemented to preserve energy include configuring the system such that the transmission rate and intensity are proportional to the strain energy. Thus, sensors 86 may include an active material that changes a material attribute in response to being deformed or displaced. Exemplary material attributes of the active material include electrical resistance. In another alternative embodiment, the energy storage device 98 may be rechargeable via a connection to the electrical system of the vehicle, or may be selectively replaceable by a user when depleted.

A motion detection system 100 includes a wireless receiver 104 that is sufficiently positioned with respect to the transmitter 90 to receive signal 92. The receiver 104 is also operatively connected to a controller 108, such as via conductive wires, to communicate to the controller 108 whether the wireless signal 92 is being transmitted by the transmitter 90. In the embodiment depicted, the receiver 104 communicates that a wireless signal 92 has been received by transmitting a motion detection signal 112 to the controller 108. Thus, the sensors 86 are operatively connected to the controller 108 for communication via transmitter 90 and receiver 104. It will be appreciated that a pre-processor could be employed to operate on the signal from the sensor or sensors 86 prior to input to the controller 108 to determine whether the signal has certain characteristics. For example, operations on the signal could include filtering, power spectral density analysis, amplification, etc.

The receiver 104 and controller 108 are depicted onboard the vehicle, i.e., mounted with respect to the vehicle body (shown at 14 in FIG. 1). However, the receiver 104 and controller 108 may be offboard the vehicle within the scope of the claimed invention. The receiver 104 may also be integrally assembled as part of the controller 108 within the scope of the claimed invention.

The system 100 may include a temperature sensor 116 that is configured to monitor the temperature inside the passenger compartment (shown at 42 in FIG. 1). The sensor 116 is operatively connected to the controller 108, such as via an electrically conductive medium, a wireless RF connection, etc., and configured to communicate the temperature of the passenger compartment to the controller 108. It should be noted that, within the scope of the claimed invention, communication by a sensor may include both the presence and the absence of an electrical or other signal when the absence of a signal is indicative of a state of a vehicle component. For example, the temperature sensor 116 may be configured to transmit a signal 120 to the controller 108 only when the temperature of the passenger compartment is above a first predetermined temperature or below a second predetermined temperature, and not when the temperature of the passenger compartment is between the first and second predetermined temperatures. The sensor 116 communicates the temperature of the passenger compartment to the controller 108 when it does not transmit signal 120 because the absence of signal 120 indicates that the temperature of the passenger compartment is between the first and second temperatures. Alternatively, and within the scope of the claimed invention, the sensor 116 may continuously transmit signal 120, which varies in amplitude, frequency, etc., to indicate the temperature of the passenger compartment. The system may also be configured to respond to situations where both the absolute temperature is outside of predetermined bounds and when the relative temperature difference between the inside and the outside of the vehicle is sufficiently large.

Other sensors or detectors 124 monitor the status of other vehicle components and conditions, and communicate the status of the other vehicle components and conditions to the controller 108. For example, a sensor 124 may communicate to the controller 108 whether the engine (not shown) is running, whether the ignition switch is in the on or off position, whether a door is open or closed, whether the transmission selector is in its park position, whether the vehicle is stationary etc.

The controller 108 is operatively connected to one or more vehicle components 128, such as via conductive wires, to selectively transmit command signals 132 to the components 128. The components 128 are responsive to the command signals 132 from the controller 108 to cause a physical change to the vehicle, such as movement of a component, activation of a component, etc. The controller 108 is also operatively connected to a telematics transmitter 136 to selectively cause the telematics transmitter 136 to transmit a wireless, radio frequency signal 140 to an offboard station 144. The signal 140 may be transmitted directly from the transmitter 136 to the station 144, or may be transmitted indirectly, such as by a satellite relay (not shown), cellular telephone system (not shown), etc. A telematics receiver 148 is configured to receive signals 152A from the offboard station 144 and is operatively connected to the controller 108 to transmit signals 152 thereto. Signals 152 and 152A convey the same information; signal 152A is a radio frequency signal and signal 152 is an electrical signal.

It should be noted that wires may be replaced by other media, such as fiber optics, conductive structural elements of the vehicle, audio or ultrasonic communication, wireless connections, etc., to transmit signals within the scope of the claimed invention.

The controller 108 is programmed to inquire whether any of sensors 86 is being deformed or displaced as a result of movement of an object inside the passenger compartment or trunk. The controller determines the answer to the inquiry by determining whether the receiver 104 is transmitting signal 112. If the signal 112 is present, then the controller 108 inquires whether the temperature inside the passenger compartment is above a first predetermined temperature or below a second predetermined temperature based on signal 120. If the controller 108 determines that the temperature inside the passenger compartment is above the first predetermined temperature or below the second predetermined temperature based on signal 120, then the controller 108 inquires whether at least one other predetermined condition exists, as determined by the sensors 124. Exemplary predetermined conditions may include whether the engine is off, whether the ignition switch is in the off position, whether any of the vehicle doors is open, whether the transmission selector is in its “park” position, whether any of the vehicle doors has been open within a predetermined period of time prior to the inquiry, etc.

If the controller 108 determines, based on signals from sensor 124, that at least one other predetermined condition exists, then the controller transmits command signals 132 to one or more components 128 thereby to cause a physical response in the one or more components, which may include the generation of sound, the movement of a vehicle component, etc. For example, the controller 108 may transmit a command signal 132 to a window regulator to cause the regulator to move a door window from its closed position to its open position, particularly, if the temperature of the passenger compartment is above a predetermined temperature. The controller may transmit a command signal 132 to the doors (shown at 22 in FIG. 1) to unlock the doors. The controller may transmit a command signal 132 to an alert system that produces an audible sound in response to the command signal. The vehicle's horn may be used as an alert system. Similarly, the audio system speakers of the vehicle body may be used to generate the audible sound (particularly in conjunction with opening the windows). The controller may transmit a command signal 132 to child locks to disengage the child locks. The controller may transmit command signals 132 to actuators to open doors, a sunroof (not shown), the rear decklid, a rear liftgate (not shown), etc. The controller may transmit a command signal to cause the vehicle's headlights or tail lights to flash.

The method may also include communicating with the offsite station 144, such as by transmitting a command signal 140A to the telematics transmitter 136, thereby causing the telematics transmitter 136 to transmit signal 140 to the offboard station 144 to alert the offboard station 144 that movement of an object is detected within the passenger compartment or trunk, the temperature within the passenger compartment is above the first predetermined temperature or below the second predetermined temperature, and at least one other predetermined condition exists. Signal 140 may also include information such as the vehicle's location, a unique identifier of the vehicle or the vehicle's registered owner, etc. The offboard station may then transmit signals 152A to the telematics receiver 148, causing the telematics receiver 148 to transmit instruction signals 152 to the controller 108. The controller 108 is responsive to the instruction signals 152 to transmit command signals 132. The offboard station 144 may be automated, or may be operated by a human operator. The offboard station 144 may determine which of components 128 are commanded by signals 132 based on varying circumstances, and may also perform other steps in response to receiving signal 140, such as determining the location of the vehicle body and notifying an entity of the condition.

For example, the entity notified may be police or other law enforcement agency, the registered owner of the vehicle (via the registered owner's cellular telephone, key fob, or other wireless communication device), a business located in close proximity to the vehicle (via telephone), persons outside the vehicle (notified by opening the vehicle windows and causing a message to be broadcast via the vehicle's audio system speakers), another driver with a telematics system in close proximity to the vehicle, etc. Accordingly, it may be desirable for the system 100 to include a global positioning system (GPS) such that the location of the vehicle is transmitted to the offsite station 144. Alternatively, cellular telephone towers could be used to triangulate position. The offboard station 144 may also receive signals from a microphone located inside the passenger compartment (not shown) via the transmitter 136 to monitor sound inside the compartment and determine a course of action. The offboard station 144 may also attempt remote communication with the passenger compartment, such as by transmitting voice signals to a speaker inside the passenger compartment.

In an alternative embodiment, the controller 108 may be programmed to transmit command signals 132, 140A in response to other sensors 124 indicating that predetermined conditions exist, independent of the temperature of the passenger compartment, and, potentially, independent of sensor 86 deformation or displacement. For example, the vehicle may include a sensor configured to monitor the gas composition (oxygen) inside the passenger compartment and to transmit a signal indicative of the gas composition to the controller 108. If the controller 108 determines that one or more predetermined gases is present above a predetermined level inside the passenger compartment, then the controller transmits command signals 132, 140A. The vehicle may include a sensor configured to monitor whether there is water entering the vehicle and to communicate whether water is entering the vehicle to the controller 108. If the controller 108 determines that water is entering the vehicle, then the controller transmits command signals 132, 140A. Similarly, a sensor may be configured to monitor particulate matter in air of the passenger compartment and communicate the amount of particulate matter to the controller 108. If the controller 108 determines that the amount of particulate matter exceeds a predetermined level, then the controller 108 transmits command signals 132, 140A.

It should be noted that the system 100 may have only one sensor 86 within the scope of the claimed invention. However, as depicted in FIG. 1, it is desirable for the vehicle 10 to include multiple sensors 86 so that movement associated with background vibration of the vehicle, as a result of raindrops, wind, passing vehicles, etc., does not cause the controller 108 to transmit signals 132, 140A. Accordingly, filtering or other processing is preferably performed by the controller 108 in the method shown in FIG. 3 to the transmission of command signals as a result of background vibration. For example, and within the scope of claimed invention, the controller 108 may inquire whether less than all of the sensors 86 are being deformed or displaced, whether the displacement or deformation of the sensors 86 is occurring at different times, etc., with the controller 108 transmitting command signals 132, 140A only if the answer to the inquiry is affirmative. The sensors 86, transmitters 90, and receiver 104 are configured such that the signal 112 transmitted to the controller 108 is unique for each of the sensors 86 so that the controller 108 can distinguish which of the sensors 86 are being deformed or displaced.

It should be noted that the sensor assemblies 78 may be mounted with respect to a system that is selectively removable from the passenger compartment, such as a portable and/or removable seating system, a cargo storage container, etc. For example, rear seat 50 includes two sensor assemblies 78 and is selectively removable from the passenger compartment by releasing the fastening elements 70 from elements 74. Similarly, sensor assemblies 78 may be mounted to removable child seats, etc. It should also be noted that, in an alternative embodiment, the temperature sensor may be operatively connected to a transmitter 90 such that signal 92 is transmitted only when the temperature sensor detects that the temperature is above a first predetermined temperature or below a second predetermined temperature.

In an alternative method, the controller may also inquire, prior to transmitting command signals 132, 140A, whether a first predetermined amount of time has passed since the occurrence of some event, such as the closure of a vehicle door or the movement of the ignition switch from the on position to the off position. If the controller determines that the first predetermined amount of time has passed, then the controller transmits a command signal to cause a first condition, such as transmitting a signal to the vehicle owner's key fob to which the key fob is responsive to create an alert, such as vibrations or sound audible to the vehicle owner. The controller may also inquire whether a second predetermined amount of time, greater than the first predetermined time, has passed since the occurrence of the event. If the controller determines that the second predetermined amount of time has passed, then the controller transmits command signals 132, 140A. It may also be desirable for the controller 108 to end the method if movement is not detected by the sensors 86 within a predetermined amount of time since the occurrence of the event, e.g., 30 minutes.

It should be noted that the systems described herein are not incompatible with, and may or may not be used in combination with, other object detection systems such as vision, radar, ultrasonic, etc. Other potential applications for sensor assemblies 78 include seat belt detect systems, power folding seats (enables remote activation/deactivation of folding capability), estimating weight and/or placement of passengers, determining occupancy of a front seat to maintain operation of entertainment or related devices when the vehicle is parked, side impact sensors, and vehicle status sensors for engine and drive train components. Sensor assemblies 78 may also be used as airbag sensors.

Referring to FIG. 4, wherein like reference numbers refer to like components from FIGS. 1-3, an alternative sensor assembly configuration is schematically depicted at 78B. The sensor assembly 78B is substantially identical to the sensor assembly 78 except that sensor assembly 78B includes to sensors 86A, 86B in electrical communication with the transmitter 90. Sensors 86A, 86B are identical to the sensor shown at 86 in FIGS. 2A, 2B, and 3. The energy management module 94 interfaces with sensors 86A, 86B simultaneously. Fused links (not shown) may be used to disconnect any malfunctioning sensors from the system.

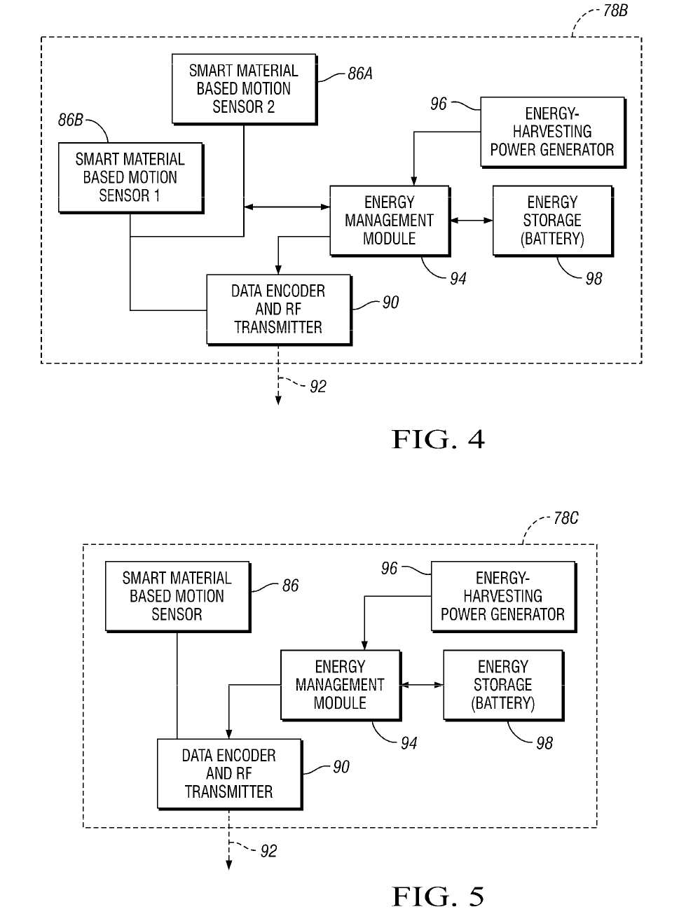

Referring to FIG. 5, wherein like reference numbers refer to like components from FIGS. 1-4, an alternative sensor assembly configuration is schematically depicted at 78C. The sensor assembly 78C is substantially identical to the sensor assembly 78 except that the sensor 86 in sensor assembly 78C is not in electrical communication with the energy management module 94, and thus does not contribute to harvesting energy for storage in energy storage device 98.

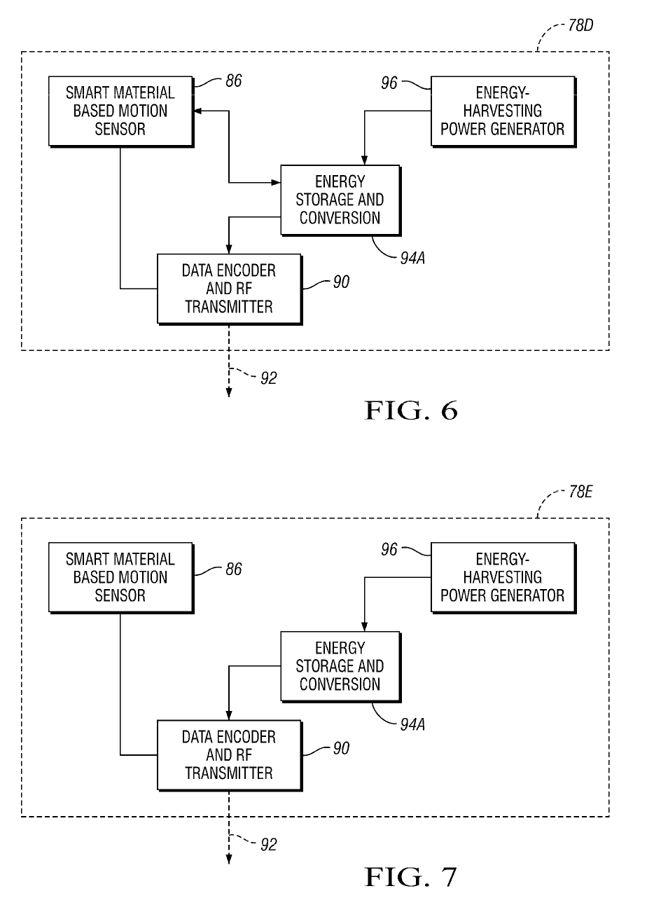

Referring to FIG. 6, wherein like reference numbers refer to like components from FIGS. 1-5, an alternative sensor assembly configuration is schematically depicted at 78D. The sensor assembly 78D is substantially identical to the sensor assembly 78 except that sensor assembly 78D includes an energy storage and conversion device in electrical communication with the energy harvester 96, the sensor 86, and the transmitter 90.

Referring to FIG. 7, wherein like reference numbers refer to like components from FIGS. 1-6, an alternative sensor assembly configuration is schematically depicted at 78E. The sensor assembly 78E is substantially identical to the sensor assembly 78D except that the sensor 86 is not in electrical communication with the energy storage and conversion device 94A. Energy storage and conversion device 94A includes a capacitor to store energy from the energy harvester 96

While the best modes for carrying out the invention have been described in detail, those familiar with the art to which this invention relates will recognize various alternative designs and embodiments for practicing the invention within the scope of the appended claims.

1. A sensor assembly comprising:
a sensor configured to detect a predetermined condition;
a transmitter operatively connected to the sensor and configured to selectively transmit a wireless signal when the sensor detects the predetermined condition;
at least one energy harvester configured to capture energy from the environment;
wherein the sensor assembly is configured to transmit energy captured by the energy harvester to the transmitter.

2. The sensor assembly of claim 1, wherein said at least one energy harvester includes the sensor; and wherein the sensor is configured to generate an electrical charge or current when the sensor is deformed or displaced.

3. The sensor assembly of claim 2, wherein the sensor includes one of a piezopolymer and a piezoceramic.

4. The sensor assembly of claim 1, wherein the sensor is configured to generate an electrical charge or current when the sensor is deformed or displaced; and wherein said at least one energy harvester is configured to capture at least one of kinetic energy, electromagnetic energy, thermal energy, and electrical energy.

5. The sensor assembly of claim 4, further comprising an energy storage device being operatively connected to said at least one energy harvester and configured to store energy captured by said at least one energy harvester, and being operatively connected to said transmitter to selectively transmit energy to said transmitter.

6. The sensor assembly of claim 1, wherein the sensor includes an active material.

7. A system for detecting an animate object inside a vehicle compartment comprising:
a vehicle body defining the vehicle compartment;
a controller;
a sensor assembly including a sensor, a transmitter, and an energy harvester;
said sensor being configured to detect a moving animate object inside the vehicle compartment and to transmit a first signal to the transmitter indicative of whether a moving animate object is detected by the sensor;
said transmitter being operatively connected to the sensor and configured to transmit a wireless second signal in response to the first signal;
said energy harvester being configured to capture energy from the sensor assembly environment;
said sensor assembly being configured to transmit energy captured by the energy harvester to the transmitter; and
a receiver operatively connected to the controller and configured to receive the second signal from the transmitter;
wherein the controller is configured to generate a command signal when the controller determines that at least one predetermined condition exists, said at least one predetermined condition including the receiver receiving the second signal from the transmitter.

8. The system of claim 7, further comprising a surface exposed to the vehicle compartment; and wherein the sensor is mounted with respect to the vehicle body such that the sensor receives a force when the moving animate object contacts the surface.

9. The system of claim 8, wherein the sensor includes one of a conductive polymer, an electroactive polymer, conductive rubber or elastomer, a stretchable resistor that changes resistance with displacement, a contact switch, an air capacitor, a compressible inductor coil, a variable transformer, and a magnet/coil system.

10. The system of claim 7, wherein the sensor assembly is configured to transmit the captured energy to the sensor to power the sensor.

11. The system of claim 7, wherein the sensor is configured to generate an electrical charge or current when deformed or displaced and is mounted with respect to the vehicle body to receive a force from the moving animate object inside the vehicle compartment; and wherein the first signal is the electrical charge or current.

12. The system of claim 11, wherein the sensor includes an active material configured to generate the charge or current.

13. The system of claim 12, wherein the active material includes at least one of a piezopolymer, a piezoceramic, an electroactive polymer, a magnetostrictive material, an ionic polymer metal composite, a magnetic shape memory alloy, a multiferroic material, and a ferroelectret foam.

14. The system of claim 7, wherein the energy harvester is configured to capture at least one of kinetic energy, electromagnetic energy, acoustic energy, and thermal energy.

15. The system of claim 7, wherein the energy harvester includes at least one of a piezopolymer, a piezoceramic, an electroactive polymer, a magnetostrictive material, an ionic polymer metal composite, a magnetic shape memory alloy, a multiferroic material, and a ferroelectret foam.

16. The system of claim 7, wherein the sensor is operatively connected to one of a door, a floor, an instrument panel, and a seat assembly.

17. A system for detecting an animate object inside a vehicle compartment comprising:
a vehicle body defining the vehicle compartment; and
a sensor including an active material configured to change a material attribute in response to being deformed or displaced, being mounted with respect to the vehicle body to receive force from a moving animate object inside the vehicle compartment, and being configured to generate a first signal that is indicative of the active material being deformed or displaced.

18. The system of claim 17, further comprising an energy harvester being configured to capture energy from the environment and being operatively connected to the sensor to power the sensor.

19. The system of claim 18, further comprising an energy storage device being operatively connected to the energy harvester to store the captured energy, and being operatively connected to the sensor to provide energy to the sensor.

20. The system of claim 17, further comprising a transmitter operatively connected to the sensor to receive the first signal and configured to transmit a wireless second signal in response to the first signal.
